(19) United States
(12) Patent Application Publication
(10) Pub. No.: US 2026/0313772 A1
(43) Pub. Date: Oct. 8, 2026

(54) LIGHT SYSTEM HAVING ENERGY-SAVING COMMUNICATION MECHANISM AND METHOID THEREOF

(71) Applicant: Xiamen PVTECH Co., Ltd., Xiamen (CN)

(72) Inventors: CHENGQUAN XU, Xiamen (CN); BANG ZOU, Xiamen (CN); FUXING LU, Xiamen (CN)

(21) Appl. No.: 19/636,906

(22) Filed: Apr. 1, 2026

(30) Foreign Application Priority Data
Apr. 2, 2025 (CN) 202510412311.7

(51) Int. Cl. H05B 47/17; H05B 47/115; H05B 47/16; H05B 47/19

(52) U.S. Cl. CPC H05B 47/17; H05B 47/115; H05B 47/16; H05B 47/19

(57) ABSTRACT

The disclosure provides a lighting system having an energy-saving communication mechanism and the method thereof. The lighting system includes a lighting device and a sentinel device. The sentinel device detects a moving object so as to generate a detection signal and execute an active mode. The sentinel device performs timing in the active mode to generate a time window, and transmits an activation signal to the lighting device to turn on the lighting device. When the sentinel device generates the detection signal again within the time window, the sentinel device executes a passive mode to perform timing again so as to refresh the time window.

### TECHNICAL FIELD

The disclosure relates to a lighting system, in particular to a lighting system having an energy-saving communication mechanism. The disclosure further relates to the energy-saving communication method of the lighting system.

### BACKGROUND

A sentinel device is a device commonly used in lighting systems, and its function is to detect moving objects. The sentinel device includes a built-in sensor capable of sensing whether moving objects are present in the surrounding environment and interacting with a lighting device. When the sentinel device detects a moving object, it immediately transmits an activation signal to the lighting device. Upon receiving the activation signal, the lighting device is turned on accordingly. However, the above mechanism may cause the power consumption of the sentinel device to be difficult to effectively control in places with frequent human traffic, because the sentinel device needs to continuously transmit signals to maintain the operating state of the lighting device. Therefore, in places with frequent human traffic, the energy consumption of the sentinel device becomes a problem that urgently needs to be addressed.

### SUMMARY

One embodiment of the disclosure provides a lighting system having an energy-saving communication mechanism, which includes a lighting device and a sentinel device. The sentinel device detects a moving object so as to generate a detection signal and execute an active mode. The sentinel device performs timing in the active mode to generate a time window, and transmits an activation signal to the lighting device to turn on the lighting device. When the sentinel device generates the detection signal again within the time window, the sentinel device executes a passive mode to perform timing again so as to refresh the time window.

Another embodiment of the disclosure provides an energy-saving communication method for a lighting system, which includes the following steps: detecting a moving object by a sentinel device to generate a detection signal and execute an active mode; performing timing by the sentinel device in the active mode to generate a time window; transmitting, by the sentinel device, an activation signal to a lighting device; emitting light by the lighting device upon receiving the activation signal; executing, by the sentinel device, a passive mode when the sentinel device generates the detection signal again within the time window; and performing timing again by the sentinel device in the passive mode so as to refresh the time window.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a block diagram of a lighting system having an energy-saving communication mechanism in accordance with a first embodiment of the disclosure.

FIG. 2 is a schematic view of an operational state of the lighting system having the energy-saving communication mechanism in accordance with the first embodiment of the disclosure.

FIG. 3 is a schematic view of a time window of the lighting system having the energy-saving communication mechanism in accordance with the first embodiment of the disclosure.

FIG. 4 is a schematic view of a refreshed time window of the lighting system having the energy-saving communication mechanism in accordance with the first embodiment of the disclosure.

FIG. 5 is a flow chart of an energy-saving communication method for a lighting system in accordance with a second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

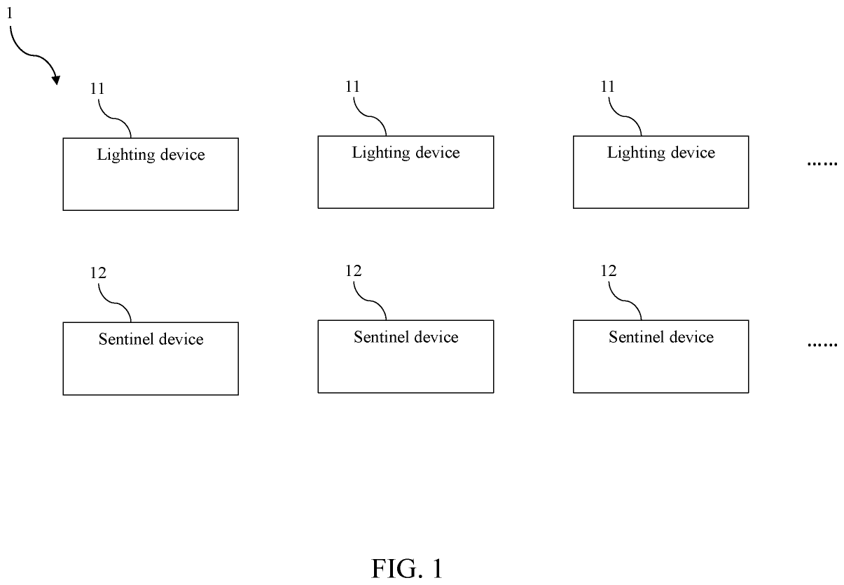

Please refer to FIG. 1, which is a block diagram of a lighting system having an energy-saving communication mechanism in accordance with a first embodiment of the disclosure. As shown in FIG. 1, the lighting system 1 includes a plurality of lighting devices 11 and a plurality of sentinel devices 12. One sentinel device 12 corresponds to one lighting device 11 and can communicate with the lighting device 11 (that is, after the sentinel device 12 detects a moving object to generate a detection signal, the sentinel device 12 transmits an activation signal to the corresponding lighting device 11 to turn on the lighting device 11). One sentinel device 12 may also correspond to a plurality of lighting devices 11 and communicate with the plurality of lighting devices 11. In this embodiment, the case in which one sentinel device 12 corresponds to one lighting device 11 is taken as an example for illustration. The number of the plurality of lighting devices 11 and the number of the plurality of sentinel devices 12 may be adjusted according to practical requirements (only three sentinel devices 12 and three lighting devices 11 are illustrated in the drawing). The sentinel device 12 may include a controller, a sensor, a communication module, and a power supply. The sensor may be a microwave sensor, an infrared sensor, or other similar components. The communication module may be a Bluetooth module, a WiFi module, a ZigBee module, or other similar components. The controller may be a microcontroller (MCU), a central processing unit (CPU), an application-specific integrated circuit chip (ASIC), or other similar components. The power supply may be a battery or an external power source (such as utility power). The lighting device 11 may be a light-emitting diode lighting device, a bulb, or a fluorescent lamp. Similarly, in addition to a light source, the lighting device 11 also includes a communication module so as to communicate with the corresponding sentinel device 12. The functions and structures of the lighting device 11 and the sentinel device 12 are well known to persons skilled in the art and will therefore not be described in further detail herein.

The embodiment just exemplifies the disclosure and is not intended to limit the scope of the disclosure; any equivalent modification and variation according to the spirit of the disclosure is to be also included within the scope of the following claims and their equivalents.

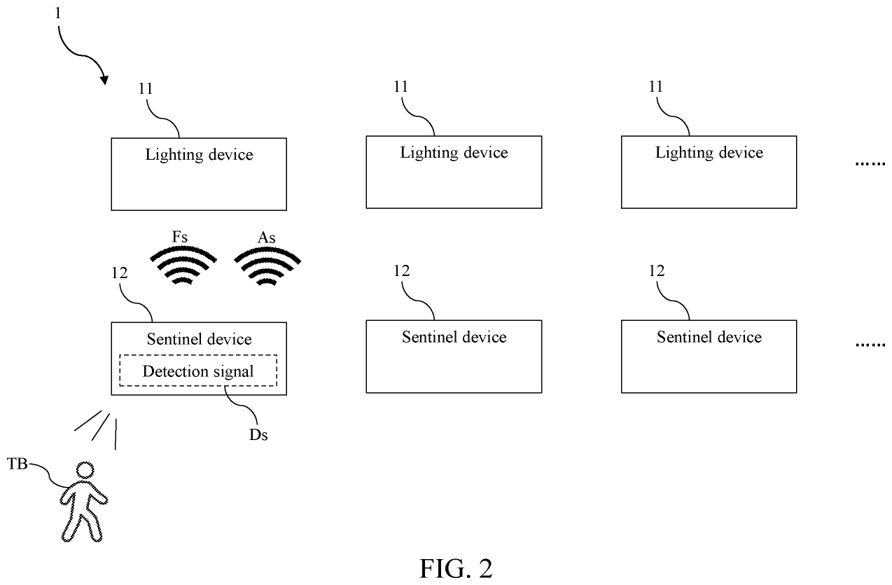

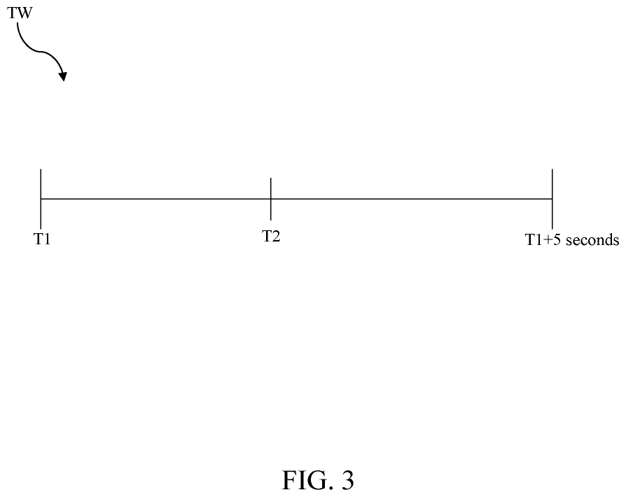

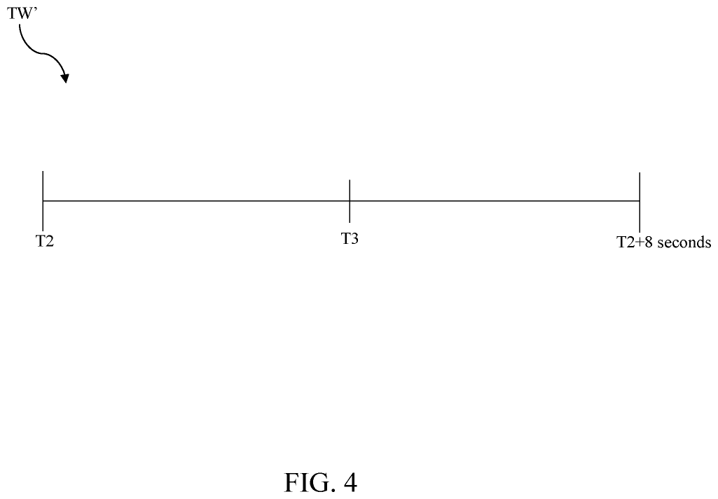

Please refer to FIG. 2, FIG. 3 and FIG. 4. FIG. 2 is a schematic view of an operational state of the lighting system having the energy-saving communication mechanism in accordance with the first embodiment of the disclosure. FIG. 3 is a schematic view of a time window of the lighting system having the energy-saving communication mechanism in accordance with the first embodiment of the disclosure. FIG. 4 is a schematic view of a refreshed time window of the lighting system having the energy-saving communication mechanism in accordance with the first embodiment of the disclosure. As shown in FIG. 2, FIG. 3 and FIG. 4, the sentinel device 12 detects a moving object TB to generate a detection signal Ds and executes an active mode. Then, the sentinel device 12 performs timing in the active mode to generate a time window TW, and transmits an activation signal As to the corresponding lighting device 11 so as to turn on the lighting device 11.

When the sentinel device 12 generates the detection signal Ds again within the time window TW, the sentinel device 12 executes a passive mode to perform timing again so as to refresh the time window TW and generate a refreshed time window TW′.

The embodiment just exemplifies the disclosure and is not intended to limit the scope of the disclosure; any equivalent modification and variation according to the spirit of the disclosure is to be also included within the scope of the following claims and their equivalents.

As shown in FIG. 3, T1 represents a time point at which the sentinel device 12 detects the moving object TB to generate the detection signal Ds, and then the sentinel device 12 performs timing at the time point T1 to generate the time window TW. At this time, the sentinel device 12 is still in the active mode. If the sentinel device 12 detects the moving object TB again (which may also be another moving object) within the time window TW (such as at time point T2), the sentinel device 12 switches to the passive mode.

The embodiment just exemplifies the disclosure and is not intended to limit the scope of the disclosure; any equivalent modification and variation according to the spirit of the disclosure is to be also included within the scope of the following claims and their equivalents.

As shown in FIG. 4, when the sentinel device 12 switches to the passive mode, the sentinel device 12 performs timing again to refresh the time window TW and generate the refreshed time window TW′. In the passive mode, when the sentinel device 12 generates the detection signal Ds, the sentinel device 12 does not transmit the activation signal As to the lighting device 11. The refreshed time window TW′ is greater than the original time window TW. If the sentinel device 12 detects the moving object TB again (which may also be another moving object) within the time window TW′ (such as at time point T3), the sentinel device 12 performs timing again to refresh the time window TW′. However, since the time window TW′ has already been refreshed once, the length thereof remains unchanged. Because the sentinel device 12 is still in the passive mode, when the sentinel device 12 generates the detection signal Ds, the sentinel device 12 does not transmit the activation signal As to the lighting device 11. In another embodiment, the time window TW′ may also be extended again. In this embodiment, the time window TW may be 5 seconds, and the refreshed time window TW′ may be 8 seconds. In another embodiment, the time window TW may be 10 seconds, and the refreshed time window TW′ may be 15 seconds. In yet another embodiment, the time window TW may be 15 seconds, and the refreshed time window TW′ may be 20 seconds. The length of the time window TW and the length of the refreshed time window TW′ may vary according to actual requirements.

The sentinel device 12 executes a sleep mode after entering the active mode. If the sentinel device 12 does not detect the moving object TB again, the sentinel device 12 is awakened after the time window TW ends to transmit a shutdown signal Fs to the lighting device 11 so as to turn off the lighting device 11.

Similarly, the sentinel device 12 executes the sleep mode after entering the passive mode. If the sentinel device 12 does not detect the moving object TB again, the sentinel device 12 is awakened after the refreshed time window TW′ ends to transmit the shutdown signal Fs to the lighting device 11 so as to turn off the lighting device 11. In the sleep mode, the controller and the communication module of the sentinel device 12 are in a sleep state, and only the sensor of the sentinel device 12 maintains normal operation so as to reduce power consumption.

As set forth above, via the energy-saving regulation mechanism integrating the active mode with the passive mode, the sentinel device 12 can extend the turn-on time of the lighting device 11 by refreshing the time window TW without repeatedly transmitting the activation signal As to the lighting device 11, when the sentinel device 12 detects the moving object TB within the time window TW. This energy-saving regulation mechanism not only simplifies the operating process of the system but also significantly reduces the energy consumption of the sentinel device 12. Due to the reduction of energy consumption, the lighting system 1 can be more efficiently applied to places with dense human traffic, such as shopping malls, stations, or office buildings. In addition, because the maintenance frequency of the sentinel device 12 is greatly reduced, the operating cost of the lighting system 1 is also reduced accordingly. In this way, the lighting system 1 can be more economically beneficial and practical in real applications.

In addition, in this embodiment, the sentinel device 12 executes the sleep mode before entering the active mode and is awakened after detecting the moving object TB to generate the detection signal Ds and execute the active mode. The sentinel device 12 executes the sleep mode after entering the passive mode and is awakened after the refreshed time window TW′ ends to transmit the shutdown signal Fs to the lighting device 11 so as to turn off the lighting device 11. From the above, it can be understood that the sentinel device 12 remains in the sleep mode for most of the time, thereby further reducing the energy consumption of the sentinel device 12. Therefore, the lighting system 11 can be applied to places with frequent human traffic without requiring frequent maintenance of the sentinel device 12, thereby better meeting actual requirements.

Further, in this embodiment, when the sentinel device 12 generates the detection signal Ds again within the time window TW, the sentinel device 12 automatically switches to the passive mode and restarts the timing function to refresh the time window TW, but does not transmit the activation signal As to the lighting device 11 during this process. The refreshed time window TW′ is greater than the original time window TW. Such a design ensures that the lighting system 1 can provide sufficient illumination for the moving object TB (such as a person or a vehicle). This time window extension mechanism not only improves the intelligence level of the system but also further optimizes energy usage efficiency, thereby avoiding energy waste caused by frequent switching of the lighting device 11. Therefore, the lighting system 1 is not only suitable for places with dense human traffic but can also function in environments with sparse human traffic. For example, the lighting system 1 may be used in remote roads, parking lots, or warehouses at night. Accordingly, the lighting system 1 not only improves user experience but also provides an effective solution for energy saving and environmental protection.

Moreover, according to the embodiments of the disclosure, the lighting system 1 can be widely applied to various smart applications, such as smart homes and smart parking lots, thereby fully satisfying practical needs. Moreover, the lighting system 1 can be combined with Internet of Things IoT technology and can further optimize energy usage efficiency. Such multifunctionality and intelligent characteristics not only expand the application scope of the lighting system 1 but also enable the lighting system 1 to be applied to future smart cities. Therefore, the lighting system 1 conforms to the dual trend of technological advancement and environmental protection.

The embodiment just exemplifies the disclosure and is not intended to limit the scope of the disclosure; any equivalent modification and variation according to the spirit of the disclosure is to be also included within the scope of the following claims and their equivalents.

It is worthy to point out that when a currently available sentinel device detects a moving object, it immediately transmits an activation signal to the lighting device. Upon receiving the activation signal, the lighting device is turned on accordingly. However, the above mechanism may cause the power consumption of the sentinel device to be difficult to effectively control in places with frequent human traffic, because the sentinel device needs to continuously transmit signals to maintain the operating state of the lighting device. Therefore, in places with frequent human traffic, the energy consumption of the sentinel device becomes a problem that urgently needs to be addressed. By contrast, according to one embodiment of the disclosure, the lighting system includes a lighting device and a sentinel device. The sentinel device detects a moving object so as to generate a detection signal and execute an active mode. The sentinel device performs timing in the active mode to generate a time window, and transmits an activation signal to the lighting device to turn on the lighting device. When the sentinel device generates the detection signal again within the time window, the sentinel device executes a passive mode to perform timing again so as to refresh the time window, but does not transmit the activation signal to the lighting device. As set forth above, through the above energy-saving regulation mechanism integrating the active mode and the passive mode, when the sentinel device detects the moving object again within the time window, the sentinel device can extend the turn-on time of the lighting device by refreshing the time window without repeatedly transmitting the activation signal to the lighting device. In this manner, the energy consumption of the sentinel device can be significantly reduced. Therefore, the lighting system can be applied to places with frequent human traffic, without requiring frequent maintenance of the sentinel device. Thus, the lighting system can meet actual requirements.

Also, according to one embodiment of the disclosure, the sentinel device executes a sleep mode before entering the active mode, and is awakened after detecting the moving object to generate the detection signal and execute the active mode. The sentinel device executes the sleep mode after entering the passive mode, and is awakened after the refreshed time window ends to transmit a shutdown signal to the lighting device so as to turn off the lighting device. As previously stated, the sentinel device remains in the sleep mode for most of the time, thereby further reducing the energy consumption of the sentinel device. Therefore, the lighting system can be applied to places with frequent human traffic, without requiring frequent maintenance of the sentinel device. Therefore, the lighting system can meet actual requirements.

Further, according to one embodiment of the disclosure, when the sentinel device generates the detection signal again within the time window, the sentinel device executes the passive mode to perform timing again so as to refresh the time window, but does not transmit the activation signal to the lighting device. The refreshed time window is greater than the original time window. Through the above time window extension mechanism, the lighting system can ensure that the moving object (such as a person or a vehicle) can obtain sufficient illumination when leaving the illumination range of the lighting device. Therefore, the lighting system can also be applied to places with sparse human traffic. As a result, the lighting system can be more comprehensive in applicant and more flexible in use.

Moreover, according to one embodiment of the disclosure, the lighting system can not only be widely applied to various smart applications, such as smart homes and smart parking lots, thereby fully satisfying practical needs. In addition, the lighting system can be combined with Internet of Things (IoT) technology and can further optimize energy use efficiency. Such multifunctionality and intelligent characteristics not only expand the application scope of the lighting system, but also enable the lighting system to be applied to future smart cities. Therefore, the lighting system conforms to the dual trend of technological advancement and environmental protection.

Furthermore, according to one embodiment of the disclosure, the lighting system has a simple design and includes a special energy-saving regulation mechanism, enabling the lighting system to reduce costs while still fully achieving the desired technical effects. The above energy-saving regulation mechanism not only significantly reduces power consumption, but also extends the service life of the sentinel device, thereby further saving maintenance costs. Therefore, the lighting system can achieve very high practicality so as to meet the needs of different applications. As described above, the lighting system having the energy-saving communication mechanism according to the embodiments of the disclosure can definitely achieve great technical effects.

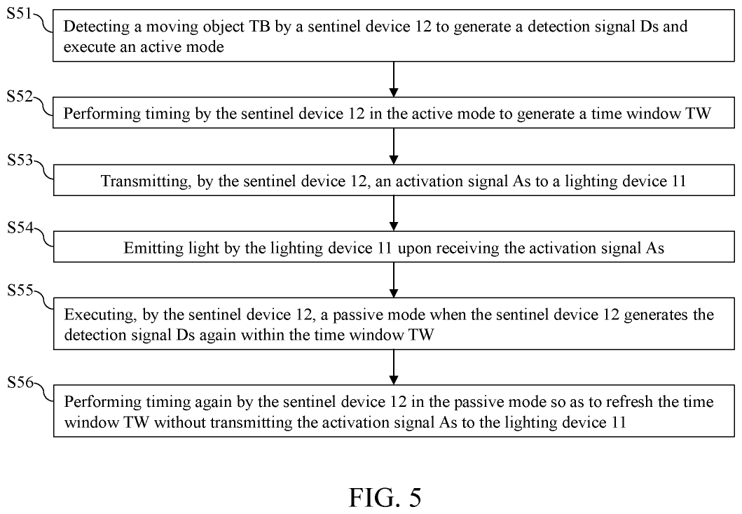

Please refer to FIG. 5, which is a flow chart of an energy-saving communication method for a lighting system in accordance with a second embodiment of the disclosure. As shown in FIG. 5, the energy-saving communication method of the lighting system in this embodiment includes the following steps:

Step S51: detecting a moving object TB by a sentinel device 12 to generate a detection signal Ds and execute an active mode.

Step S52: performing timing by the sentinel device 12 in the active mode to generate a time window TW.

Step S53: transmitting, by the sentinel device 12, an activation signal As to a lighting device 11.

Step S54: emitting light by the lighting device 11 upon receiving the activation signal As.

Step S55: executing, by the sentinel device 12, a passive mode when the sentinel device 12 generates the detection signal Ds again within the time window TW.

Step S56: performing timing again by the sentinel device 12 in the passive mode so as to refresh the time window TW without transmitting the activation signal As to the lighting device 11.

As previously stated, through the energy-saving regulation mechanism integrating the active mode with the passive mode, the sentinel device 12 can extend the turn-on time of the lighting device 11 by refreshing the time window TW without repeatedly transmitting the activation signal As to the lighting device 11 when the sentinel device 12 detects the moving object TB within the time window TW. This energy-saving regulation mechanism not only simplifies the operating procedure of the system but also significantly reduces the energy consumption of the sentinel device 12. Due to the reduction in energy consumption, the lighting system 1 can be more efficiently applied to places with dense human traffic, such as shopping malls, stations, or office buildings. In addition, because the maintenance frequency of the sentinel device 12 is greatly reduced, the operating cost of the lighting system 1 is also correspondingly lowered. Thus, the lighting system 1 can be more economically beneficial and practical in real applications.

In addition, as described above, the sentinel device 12 executes the sleep mode before entering the active mode and is awakened after detecting the moving object TB to generate the detection signal Ds and execute the active mode. The sentinel device 12 executes the sleep mode after entering the passive mode and is awakened after the refreshed time window TW′ ends to transmit the shutdown signal Fs to the lighting device 11 so as to turn off the lighting device 11. Accordingly, the sentinel device 12 remains in the sleep mode for most of the time, thereby further reducing the energy consumption of the sentinel device 12. Therefore, the lighting system 11 can be applied to places with frequent human traffic without requiring frequent maintenance of the sentinel device 12 so as to meet actual requirements.

The embodiment just exemplifies the disclosure and is not intended to limit the scope of the disclosure; any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the disclosure, the lighting system includes a lighting device and a sentinel device. The sentinel device detects a moving object so as to generate a detection signal and execute an active mode. The sentinel device performs timing in the active mode to generate a time window, and transmits an activation signal to the lighting device to turn on the lighting device. When the sentinel device generates the detection signal again within the time window, the sentinel device executes a passive mode to perform timing again so as to refresh the time window, but does not transmit the activation signal to the lighting device. As set forth above, through the above energy-saving regulation mechanism integrating the active mode and the passive mode, when the sentinel device detects the moving object again within the time window, the sentinel device can extend the turn-on time of the lighting device by refreshing the time window without repeatedly transmitting the activation signal to the lighting device. In this manner, the energy consumption of the sentinel device can be significantly reduced. Therefore, the lighting system can be applied to places with frequent human traffic, without requiring frequent maintenance of the sentinel device. Thus, the lighting system can meet actual requirements.

Also, according to one embodiment of the disclosure, the sentinel device executes a sleep mode before entering the active mode, and is awakened after detecting the moving object to generate the detection signal and execute the active mode. The sentinel device executes the sleep mode after entering the passive mode, and is awakened after the refreshed time window ends to transmit a shutdown signal to the lighting device so as to turn off the lighting device. As previously stated, the sentinel device remains in the sleep mode for most of the time, thereby further reducing the energy consumption of the sentinel device. Therefore, the lighting system can be applied to places with frequent human traffic, without requiring frequent maintenance of the sentinel device. Therefore, the lighting system can meet actual requirements.

Further, according to one embodiment of the disclosure, when the sentinel device generates the detection signal again within the time window, the sentinel device executes the passive mode to perform timing again so as to refresh the time window, but does not transmit the activation signal to the lighting device. The refreshed time window is greater than the original time window. Through the above time window extension mechanism, the lighting system can ensure that the moving object (such as a person or a vehicle) can obtain sufficient illumination when leaving the illumination range of the lighting device. Therefore, the lighting system can also be applied to places with sparse human traffic. As a result, the lighting system can be more comprehensive in applicant and more flexible in use.

Moreover, according to one embodiment of the disclosure, the lighting system can not only be widely applied to various smart applications, such as smart homes and smart parking lots, thereby fully satisfying practical needs. In addition, the lighting system can be combined with Internet of Things (IoT) technology and can further optimize energy use efficiency. Such multifunctionality and intelligent characteristics not only expand the application scope of the lighting system, but also enable the lighting system to be applied to future smart cities. Therefore, the lighting system conforms to the dual trend of technological advancement and environmental protection.

Furthermore, according to one embodiment of the disclosure, the lighting system has a simple design and includes a special energy-saving regulation mechanism, enabling the lighting system to reduce costs while still fully achieving the desired technical effects. The above energy-saving regulation mechanism not only significantly reduces power consumption, but also extends the service life of the sentinel device, thereby further saving maintenance costs. Therefore, the lighting system can achieve very high practicality so as to meet the needs of different applications.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. A lighting system having an energy-saving communication mechanism, comprising:
a lighting device; and
a sentinel device configured to detect a moving object so as to generate a detection signal and execute an active mode, wherein the sentinel device is configured to perform a timing in the active mode to generate a time window, and transmit an activation signal to the lighting device to turn on the lighting device; and
wherein when the sentinel device generates the detection signal again within the time window, the sentinel device executes a passive mode to perform the timing again so as to refresh the time window.

2. The lighting system as claimed in claim 1, wherein when the sentinel device generates the detection signal again in the passive mode, the sentinel device is configured to refresh the time window without transmitting the activation signal to the lighting device.

3. The lighting system as claimed in claim 1, wherein the sentinel device is configured to execute a sleep mode before entering the active mode, and is awakened after detecting the moving object to generate the detection signal and execute the active mode.

4. The lighting system as claimed in claim 3, wherein the sentinel device is configured to execute the sleep mode again after entering the passive mode, and is awakened after a refreshed time window ends to transmit a shutdown signal to the lighting device so as to turn off the lighting device.

5. The lighting system as claimed in claim 1, wherein the refreshed time window is greater than the original time window.

6. An energy-saving communication method for a lighting system, comprising:
detecting a moving object by a sentinel device to generate a detection signal and execute an active mode;
performing a timing by the sentinel device in the active mode to generate a time window;
transmitting, by the sentinel device, an activation signal to a lighting device;
emitting light by the lighting device upon receiving the activation signal;
executing, by the sentinel device, a passive mode when the sentinel device generates the detection signal again within the time window; and
performing the timing again by the sentinel device in the passive mode so as to refresh the time window.

7. The energy-saving communication method as claimed in claim 6, further comprising:
refreshing the time window without transmitting the activation signal to the lighting device when the sentinel device generates the detection signal again in the passive mode.

8. The energy-saving communication method as claimed in claim 6, further comprising:
executing a sleep mode by the sentinel device before entering the active mode; and
awakening the sentinel device after detecting the moving object so as to generate the detection signal and execute the active mode.

9. The energy-saving communication method as claimed in claim 8, further comprising:
executing the sleep mode again by the sentinel device after entering the passive mode; and
awakening the sentinel device after a refreshed time window ends to transmit a shutdown signal to the lighting device so as to turn off the lighting device.

10. The energy-saving communication method as claimed in claim 6, wherein the refreshed time window is greater than the original time window.
